(19) United States
(12) Patent Application Publication
(10) Pub. No.: US 2013/0336189 A1
(43) Pub. Date: Dec. 19, 2013

(54) METHODS AND APPARATUS FOR DECODING MULTIMEDIA BROADCAST AND MULTICAST SERVICE (MBMS) DATA

(71) Applicant: QUALCOMM INCORPORATED, San Diego, CA (US)

(72) Inventors: Amit Mandil, Hyderabad (IN); Pratik Kotkar, San Diego, CA (US); Omar Moh'd Said Sabbarini, San Diego, CA (US); Prasanna Venkata Santosh Kumar Tallapragada, San Diego, CA (US)

(73) Assignee: QUALCOMM Incorporated, San Diego, CA (US)

(21) Appl. No.: 13/790,918

(22) Filed: Mar. 8, 2013

(30) Foreign Application Priority Data
Jun. 18, 2012 (IN) 1872/DEL/2012

(51) Int. Cl. H04L 12/18

(52) U.S. Cl. CPC H04L 12/189
USPC 370/312

(57) ABSTRACT

Certain aspects of the present disclosure relate to methods and apparatus for decoding Multimedia Broadcast and Multicast Service (MBMS) data. A User Equipment (UE) may receive a Multicast Control Channel (MCCH) and Multicast Channel Scheduling Information (MSI) in a same subframe of a scheduling period, the MCCH and the MSI relating to one or more MBMS services provided in a Multimedia Broadcast Single Frequency Network (MBSFN) area. The UE may configure at least a first control layer for the one or more MBMS services based on the MCCH and retain the MSI at least until the configuring is complete. The UE may thereafter configure at least a second control layer for the one or more MBMS services based on the MSI.

### CLAIM OF PRIORITY UNDER 35 U.S.C. §119

The present Application for Patent claims priority to Indian Provisional Application No. 1872/DEL/2012, entitled “METHODS AND APPARATUS FOR DECODING MULTIMEDIA BROADCAST AND MULTICAST SERVICE (MBMS) DATA,” filed Jun. 18, 2012, and assigned to the assignee hereof and hereby expressly incorporated by reference herein.

### BACKGROUND

1. Field

The present disclosure relates generally to communication systems, and more particularly, to methods and apparatus for decoding Multimedia Broadcast and Multicast Service (MBMS) data.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Certain aspects of the present disclosure provide a method for wireless communications by a User Equipment (UE). The method generally includes receiving a Multicast Control Channel (MCCH) and Multicast Channel Scheduling Information (MSI) in a same subframe of a scheduling period, the MCCH and the MSI relating to one or more Multimedia Broadcast and Multicast Service (MBMS) services provided in a Multimedia Broadcast Single Frequency Network (MBSFN) area, configuring at least a first control layer for the one or more MBMS services based on the MCCH, retaining the MSI at least until the configuring is complete, and configuring at least a second control layer for the one or more MBMS services based on the MSI.

Certain aspects of the present disclosure provide an apparatus for wireless communications by a User Equipment (UE). The apparatus generally includes means for receiving a Multicast Control Channel (MCCH) and Multicast Channel Scheduling Information (MSI) in a same subframe of a scheduling period, the MCCH and the MSI relating to one or more Multimedia Broadcast and Multicast Service (MBMS) services provided in a Multimedia Broadcast Single Frequency Network (MBSFN) area, means for configuring at least a first control layer for the one or more MBMS services based on the MCCH, means for retaining the MSI at least until the configuring is complete, and means for configuring at least a second control layer for the one or more MBMS services based on the MSI.

Certain aspects of the present disclosure provide an apparatus for wireless communications by a User Equipment (UE). The apparatus generally includes at least one processor and a memory coupled to the at least one processor. The at least one processor is generally configured to receive a Multicast Control Channel (MCCH) and Multicast Channel Scheduling Information (MSI) in a same subframe of a scheduling period, the MCCH and the MSI relating to one or more Multimedia Broadcast and Multicast Service (MBMS) services provided in a Multimedia Broadcast Single Frequency Network (MBSFN) area, configure at least a first control layer for the one or more MBMS services based on the MCCH, retain the MSI at least until the configuring is complete, and configure at least a second control layer for the one or more MBMS services based on the MSI.

Certain aspects of the present disclosure provide a computer program product for wireless communications by a User Equipment (UE). The computer program product generally includes computer-readable medium comprising code for receiving a Multicast Control Channel (MCCH) and Multicast Channel Scheduling Information (MSI) in a same subframe of a scheduling period, the MCCH and the MSI relating to one or more Multimedia Broadcast and Multicast Service (MBMS) services provided in a Multimedia Broadcast Single Frequency Network (MBSFN) area, configuring at least a first control layer for the one or more MBMS services based on the MCCH, retaining the MSI at least until the configuring is complete, and configuring at least a second control layer for the one or more MBMS services based on the MSI.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 is a diagram illustrating evolved Multicast Broadcast Multimedia Service (eMBMS) in a Multi-Media Broadcast over a Single Frequency Network.

FIG. 8 shows a flow diagram illustrating operations 800 performed by a user equipment (UE) for decoding MBMS data, in accordance with certain aspects of the present disclosure.

FIG. 8A illustrates example components capable of performing the operations illustrated in FIG. 8, in accordance with certain aspects of the present disclosure.

FIG. 9 shows a flow diagram illustrating operations 900 performed by a user equipment (UE) for decoding desired MBMS data, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software/firmware, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software/firmware, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

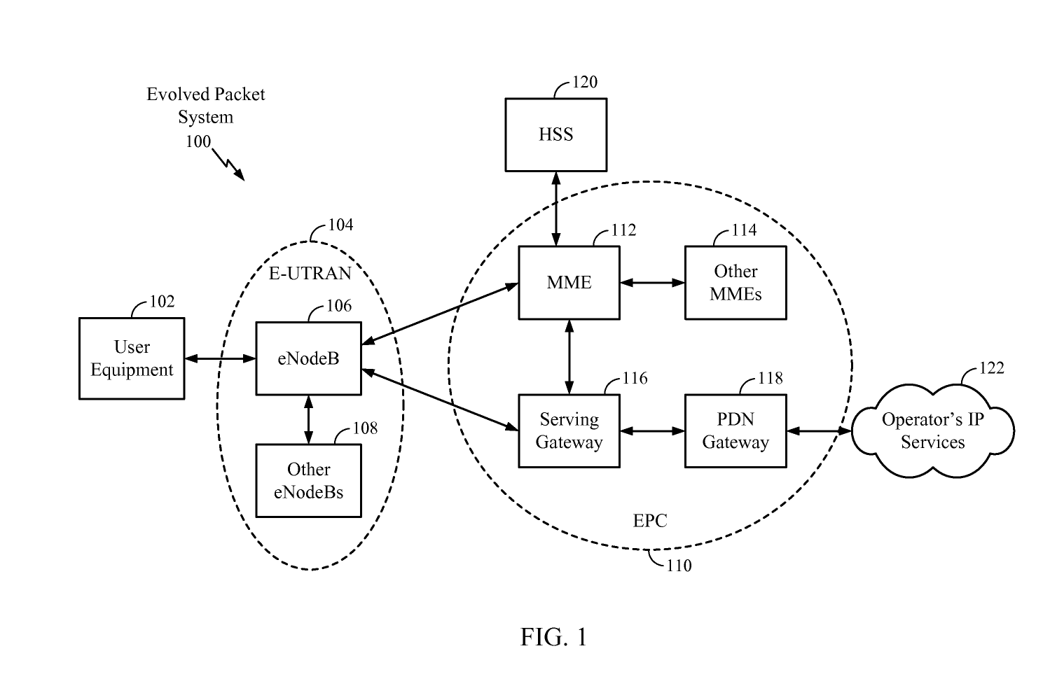

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS Streaming Service (PSS). In this manner, the UE 102 may be coupled to the PDN through the LTE network.

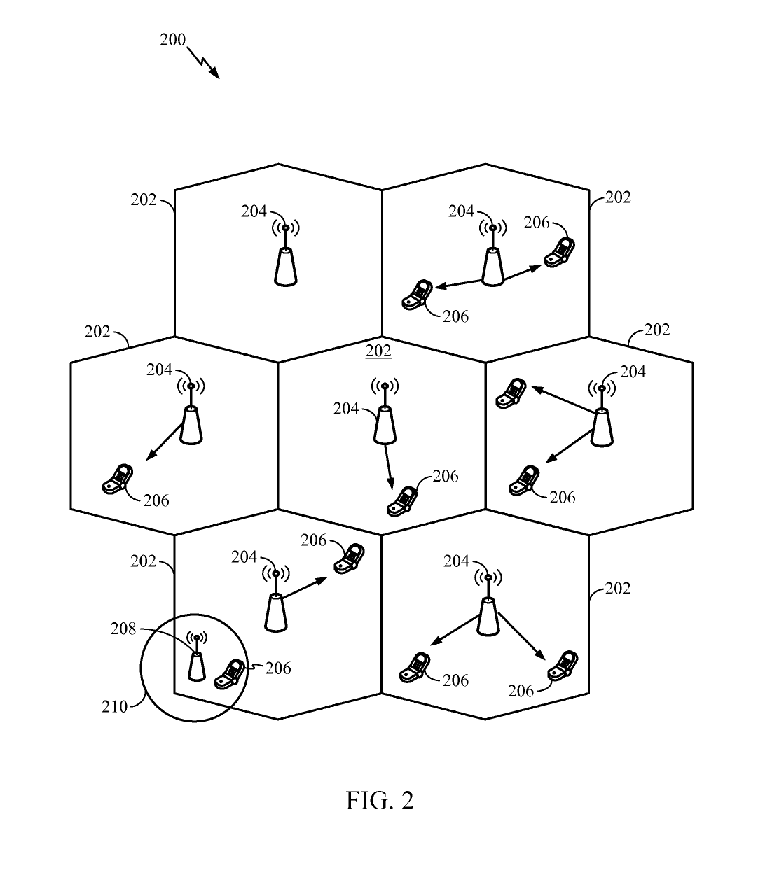

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

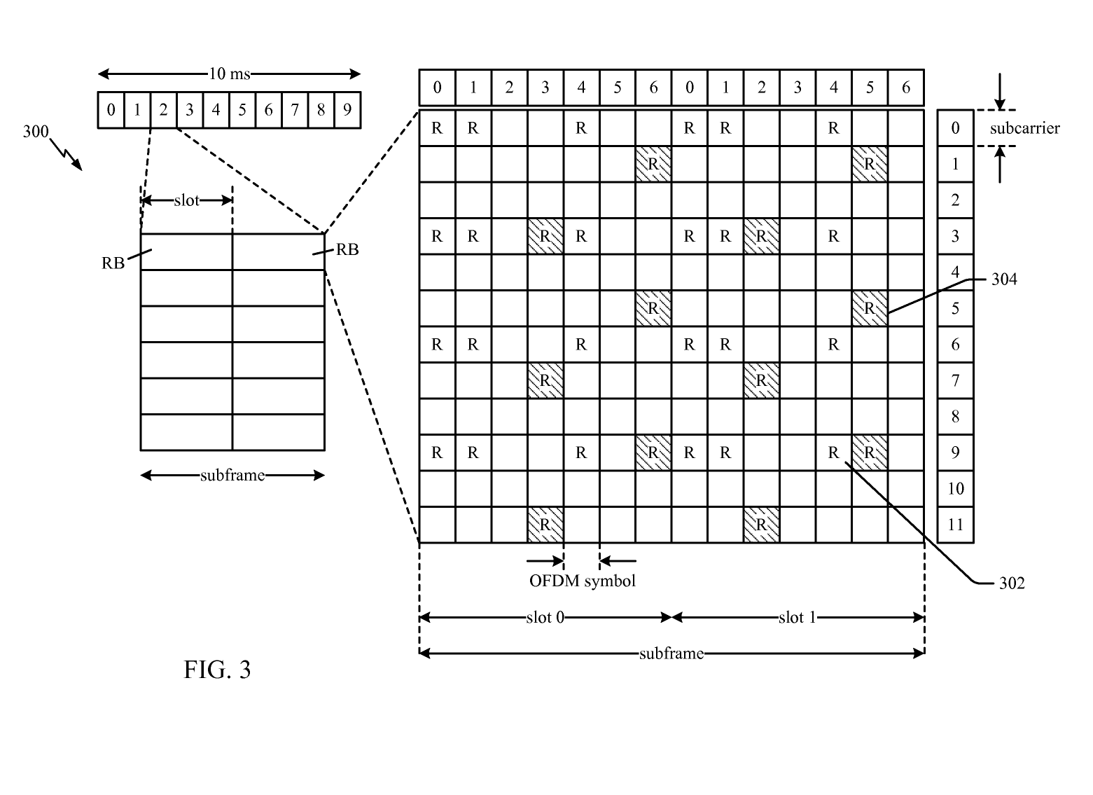

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

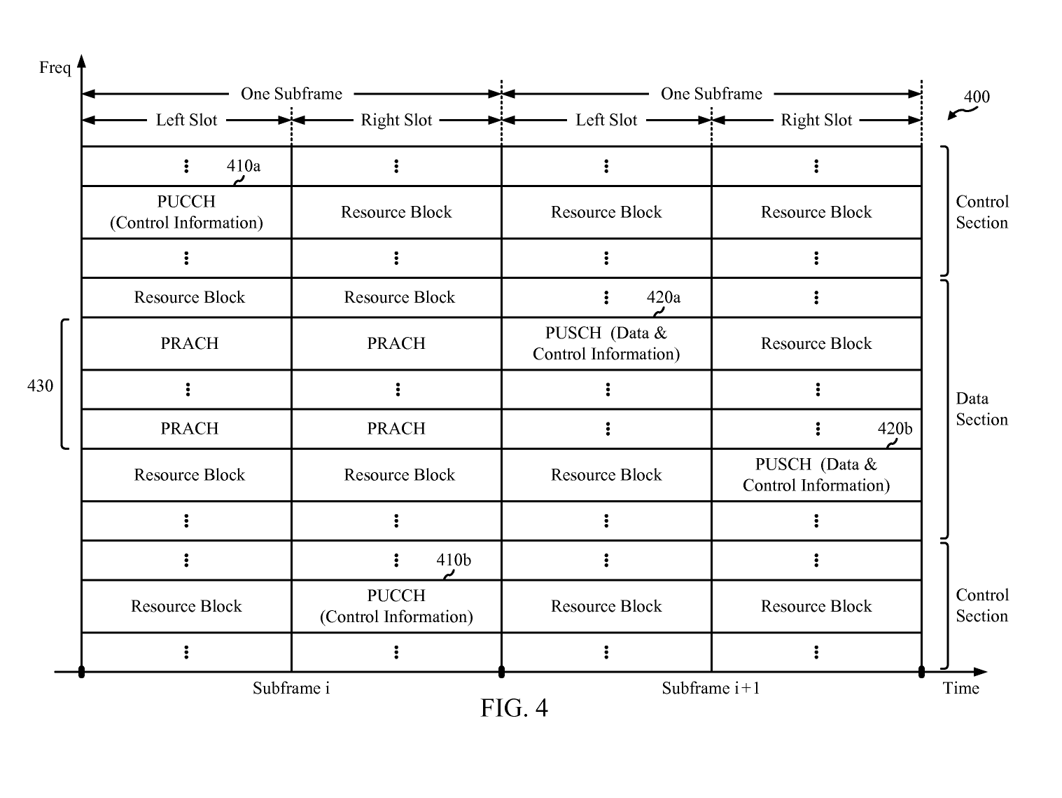

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

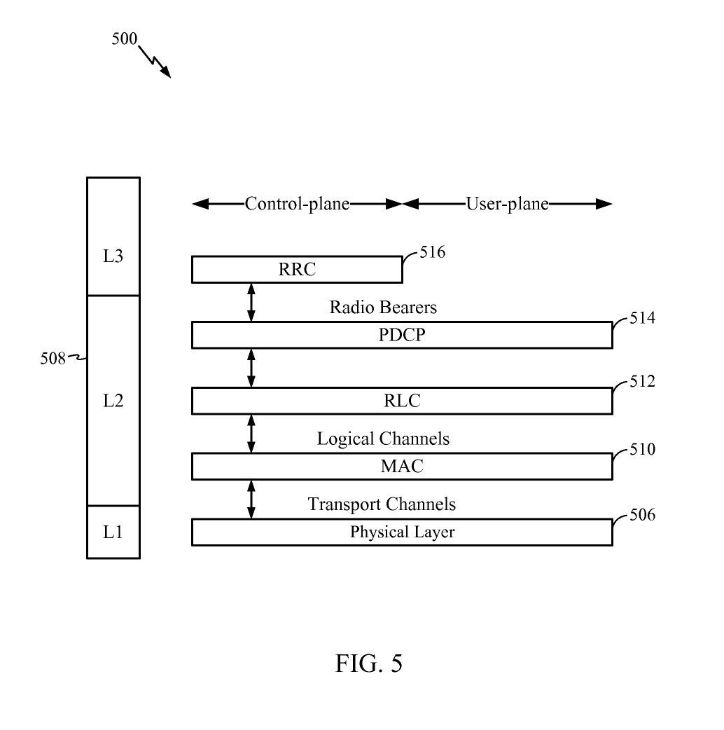

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

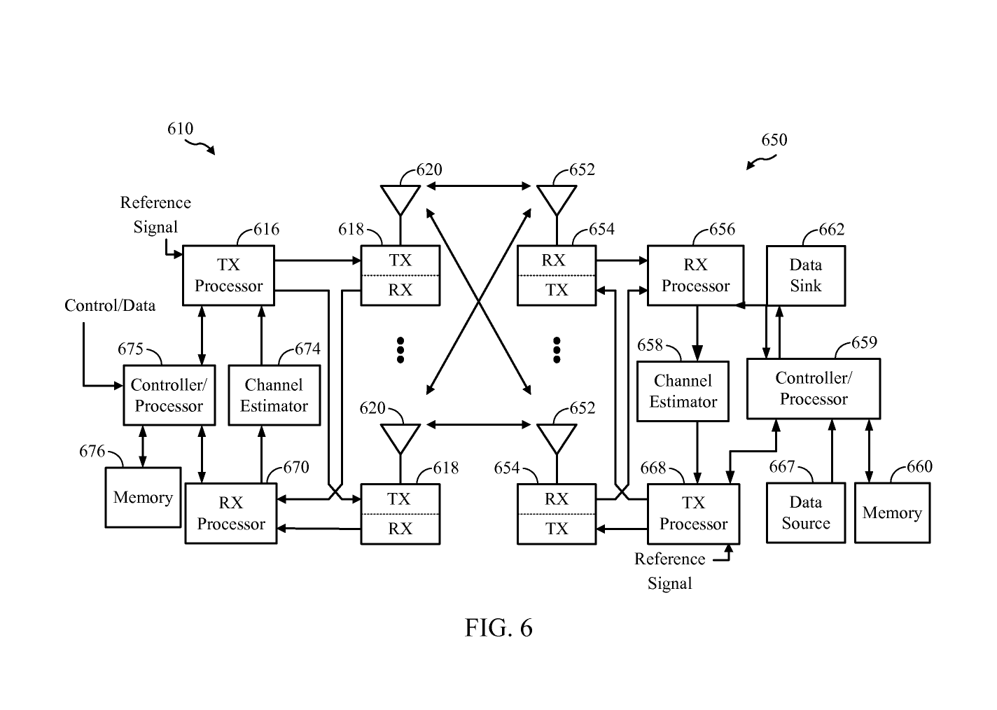

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

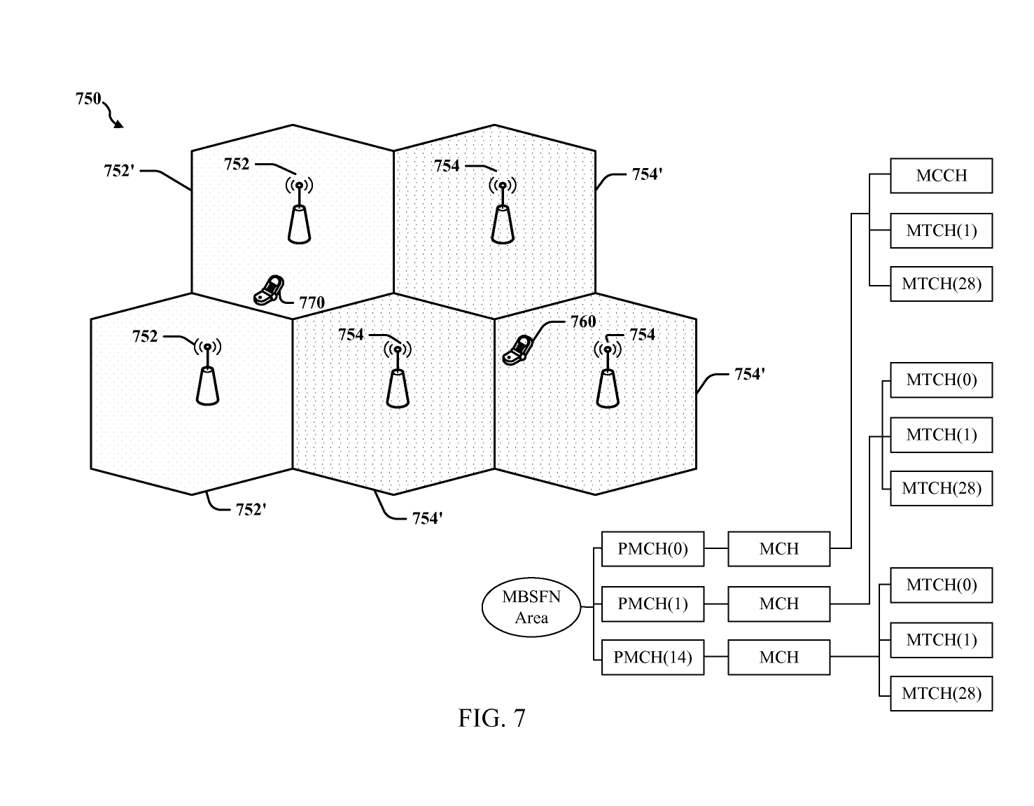

FIG. 7 is a diagram 750 illustrating evolved Multicast Broadcast Multimedia Service (eMBMS) in a Multi-Media Broadcast over a Single Frequency Network (MBSFN). The eNBs 752 in cells 752′ may form a first MBSFN area and the eNBs 754 in cells 754′ may form a second MBSFN area. The eNBs 752, 754 may be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

### Example Methods and Apparatus for Decoding Multimedia Broadcast and Multicast Service (MBMS) Data

A Multimedia Broadcast and Multicast Service (MBMS) service area is an area providing one or more Enhanced MBMS (eMBMS) services. An MBMS service area may be divided into one or more Multimedia Broadcast Single Frequency Network (MBSFN) areas. As noted above, each MBSFN area typically includes one or more eNBs which may be used for synchronized transmission of the same eMBMS content in the MBSFN area. In certain aspects, an MBSFN area may be used to broadcast different eMBMS services. In certain aspects, the size of an MBSFN area may be as small as one cell.

The PMCH is a downlink physical layer channel that carries data (both control and traffic) originating from higher protocol layers for MBMS using MBSFN operation. Thus, the PMCH must be decoded for any control or traffic MBMS data. As noted above, an MBSFN area may include multiple PMCHs. Each PMCH may be mapped to a logical control channel—Multicast Control channel (MCCH) for carrying eMBMS control information, and one or more logical traffic channel—Multicast Traffic Channel (MTCH) for carrying eMBMS traffic. In certain aspects, each PMCH may carry multiple eMBMS services distributed over MBSFN subframes allocated for the PMCH.

In certain aspects, an eMBMS capable UE needs to receive and decode System Information Block-2 (SIB2), SIB-13 and the Multicast Control channel (MCCH) in order to be able to listen to desired eMBMS services transmitted by cells in a particular MBSFN area. SIB2 generally provides information about downlink (DL) subframes which are allocated for MBSFN purpose among all MBSFN areas. SIB13 typically contains information about MBSFN subframes used by eNBs to transmit the MCCH in a particular MBSFN area. The MCCH carries an MBSFNAreaConfiguration message. The MBSFNAreaConfiguration is an MBSFN area specific MBMS control information which tells the UE about distribution of MBSFN subframes allocated for eMBMS data in a particular MBSFN area. It may also provide information regarding how these allocated MBSFN subframes are distributed among different PMCHs for the particular MBSFN area. The MCCH, for example, may carry information about what different eMBMS services each PMCH may carry and logical channel identifiers to identify each service. In an aspect, each logical channel identifier may correspond to one eMBMS service and the MCCH may include a mapping between each PMCH and logical channels carried by the PMCH.

In certain aspects, the allocated MBSFN subframes for each PMCH repeats every Multicast Channel (MCH) period called MCH scheduling period (MSP). In an aspect, the MSP may be a configurable parameter.

In a particular MBSFN area, MBSFN subframes are distributed among multiple eMBMS services. The UE must decode MCCH to know which PMCHs may potentially contain subframes related to one or more desired eMBMS services for a particular MBSFN area. However to know which subframes of a particular PMCH carry a service of interest the UE must decode MCH Scheduling information (MSI) for the particular PMCH. MSI is MAC control element included in the first allocated MBSFN subframe every MSP for a particular PMCH carrying different services. The eNB may use the MSI to indicate to the UE which of the transport subframes in the MTCH are scheduled for data related to a particular eMBMS service for a particular PMCH and/or which subframes of the PMCH are unused. Each MSI corresponds to scheduling information for only one PMCH for a particular MBSFN area and provides information on which subframes of the PMCH carry data related to which service. Thus, having decoded the MCCH, the UE, based on the services it wants to monitor (or is interested in) and the MCH scheduling information from decoding the MSI, may only monitor a certain number of subframes in a given PMCH instead of monitoring all subframes of the PMCH for the desired eMBMS services.

In certain aspects, generally at a receiver (e.g, UE), a Radio Resource Control (RRC) layer receives the MCCH, and a lower Medium Access Control (MAC) layer receives the MSI. A physical L1 layer monitors the subframes of interest based on the instructions from the RRC and the MAC layers. The RRC layer decodes the MCCH and configures the MAC and L1 layers to start monitoring for eMBMS data on PMCHs that may carry services of interest to the UE. Once configured, the MAC layer may detect and decode the MSI for the monitored PMCH in a current MSP and direct the L1 layer to monitor for subframes indicated as carrying the eMBMS services of interest. In this manner, the MAC layer may be configured based on the MSI. In certain aspects, once RRC configures the MAC layer the UE may decode the subframes having desired service data for the current MSP and subsequent MSPs.

In certain aspects, the UE may receive a unicast message carrying information about which physical channels may contain eMBMS services. The UE may then decode the MCCH and MSI in order to decode data relating to a service of interest on a particular physical channel.

In certain aspects, if the MCCH and the MSI (corresponding to a particular PMCH) are received in the same subframe (e.g. first subframe of an MSP when the UE is trying to get MBSFN area control information for the first time), the RRC and the MAC layers may respectively receive the MCCH and the MSI, for example, simultaneously. At this time, since the MCCH may not yet have been decoded by the RRC layer and the MAC and L1 layers may not have been configured for eMBMS services, the UE may not know whether there are any available eMBMS services in the current MBSFN area, and if yes, which PMCHs carry the eMBMS desired services. Thus, the UE may not even be looking for eMBMS data or trying to decode subframes for eMBMS data. Accordingly, the MAC layer may discard the received MSI.

Once the MCCH is decoded, the MAC and L1 layers may be configured for eMBMS services. However, the MAC layer may already have discarded the MSI as noted above. Thus, if the UE now wants to decode one or more services (or logical channels) of interest in the current MSP, it may have to decode all subframes (blind decoding) of the PMCH received in the current MSP in an attempt to find the desired service(s). For example, the discarded MSI may have had information that a desired service is carried only by certain subframes of the particular PMCH in the current MSP. However, in the absence of the MSI, the UE may have to monitor all allocated MBSFN subframes of the particular PMCH for the current MSP. Thus, the UE may have to monitor the PMCH for periods which actually do not carry desired data, when it may have slept and saved battery power for these periods of the MSP. Since the UE may have to monitor more subframes than it generally would if it had the MSI, this may cost more battery power.

The same phenomenon may repeat when the UE activates for a first time and starts monitoring eMBMS services or after deactivating/stopping eMBMS services.

In certain aspects, when the MCCH and the MSI are received by the UE in the same subframe (e.g. first subframe of an MSP), the MAC layer may retain the MSI without discarding, for example, at least until the RRC layer has configured the lower MAC and/or L1 layers for eMBMS services. Once the lower layers are configured, the retained MSI information may be decoded by the configured MAC layer and used to monitor only those subframes that may contain services of interest.

Thus, the UE can selectively decode subframes and sleep for periods when it does not have to monitor for services of interest and save battery power. For example, if the UE knows that the current MSP does not have services of interest, it may sleep for the entire MSP. This may save extra PMCH decodes for the first MSP, thus increasing chances of UE idle time in either idle mode or connected mode and may save battery consumption.

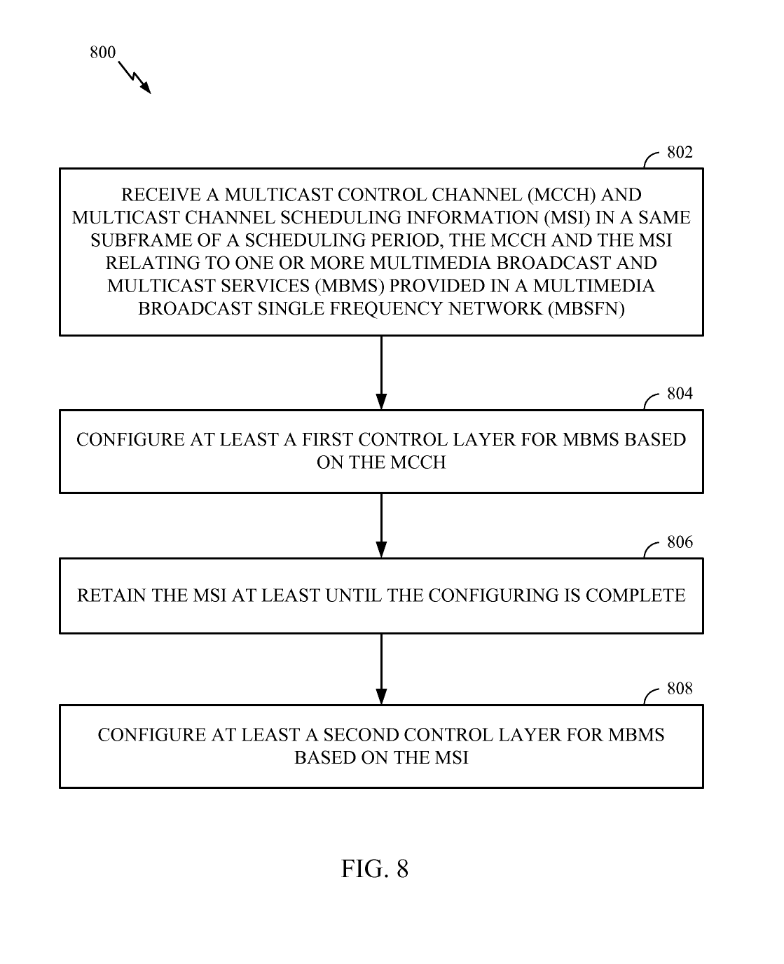

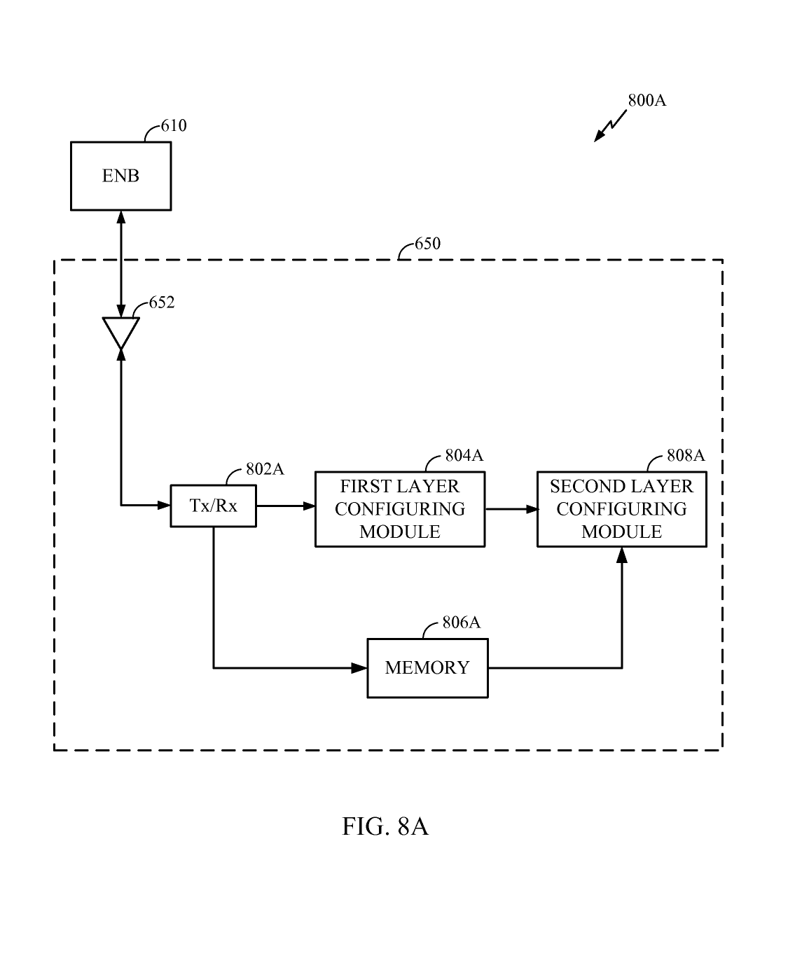

FIG. 8 shows a flow diagram illustrating operations 800 performed by a user equipment (UE) for decoding MBMS data, in accordance with certain aspects of the present disclosure. Operations 800 may begin, at 802 by receiving MCCH and MSI in a same subframe of a scheduling period, the MCCH and the MSI relating to one or more MBMS services provided in a MBSFN area. At 804, at least a first control layer may be configured for the one or more MBMS services based on the MCCH. At 806, the MSI may be retained at least until the configuring is complete. At 808, at least a second control layer may be configured for the one or more MBMS services based on the MSI.

In an aspect, the scheduling period includes a Multicast Channel Scheduling Period (MSP), the first control layer includes a RRC layer, and the second control layer includes a MAC layer. The one or more MBMS services may include one or more eMBMS services.

In certain aspects, operations 800 may further include decoding data for at least a portion of the scheduling period or not decoding data based on the MCCH and the decoded MSI. In an aspect, the decoded data may relate to at least one eMBMS service carried by a PMCH.

In certain aspects, operations 800 may further include executing a sleep procedure by the UE for one or more portions of the scheduling period during which data is not scheduled for the UE.

In certain aspects, the MAC layer may be configured by the RRC layer based on the MCCH. In an aspect, the configuring of the RRC layer may include providing information to the RRC layer regarding mapping of each PMCH to logical channel identifiers of MBMS services carried by the PMCH. In an aspect, the configuring of the MAC layer may include providing information to the MAC layer regarding position of all MTCH used for eMBMS services and unused allocated MBSFN subframes on a MCH for this particular PMCH. In an aspect, each logical channel identifier may correspond to an eMBMS service.

In an aspect, retaining the MSI may include storing the MSI in a memory at the UE.

The operations 800 described above may be performed by any suitable components or other means capable of performing the corresponding functions of FIG. 8. For example, operations 800 illustrated in FIG. 8 correspond to components 800A of a UE 650. In FIG. 8A, a receiver 802A may receive a MCCH and MSI in a same subframe of a scheduling period, for example from a eNB 610 belonging to an MBSFN area. A first layer configuring module 804A may configure at least a first control layer for MBMS services based on the MCCH. Meanwhile, a memory 806A may retain (e.g., store) the received MSI at least until the configuring of the first control layer is complete. A second layer configuring module 808A may thereafter configure at least a second control layer for MBMS services based on the retained MSI.

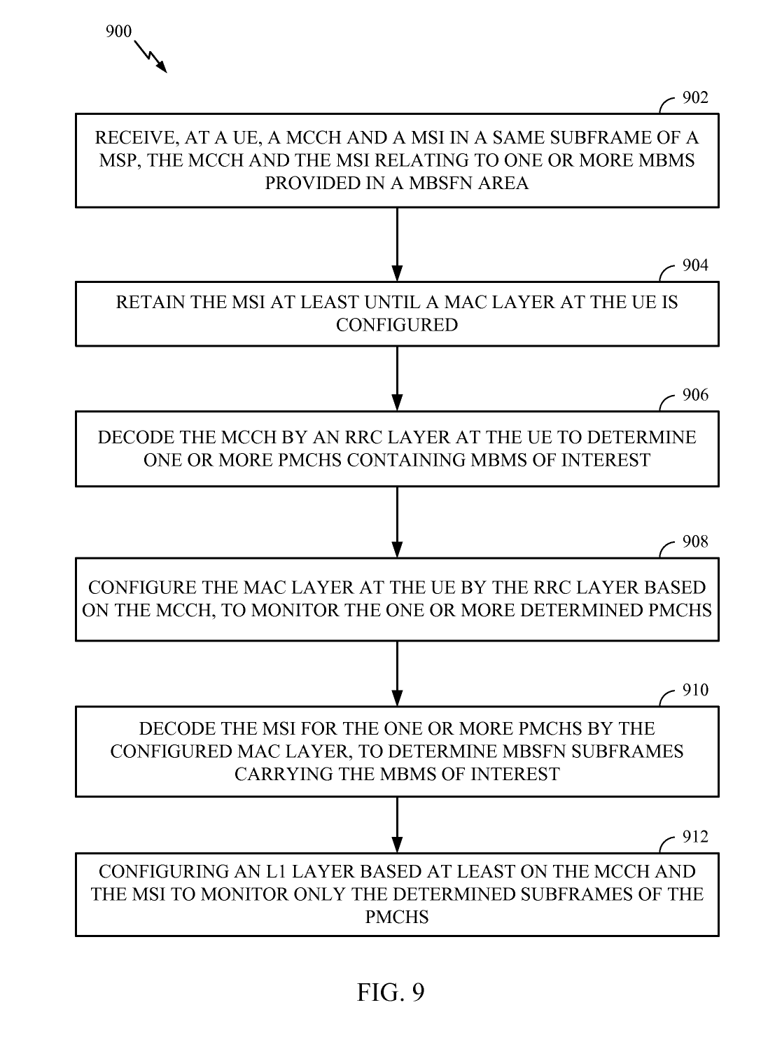

FIG. 9 shows a flow diagram illustrating operations 900 performed by a user equipment (UE) for decoding desired MBMS data, in accordance with certain aspects of the present disclosure. Operations 900 may begin, at 902, by receiving MCCH and MSI in a same subframe, wherein the MCCH and the MSI relate to one or more MBMS services provided in a MBSFN area. At 904, the UE may retain (e.g., store) the received MSI for later use. In an aspect, the UE may retain the MSI at least until a MAC layer of the UE is configured for MBMS services. At 906, a RRC layer at the UE may decode the received MCCH to determine one or more PMCHs containing MBMS services of interest to the UE. At 908, the RRC layer may configure a MAC layer at the UE, based on the MCCH to monitor the one or more determined PMCHs. At 910, the configured MAC layer may decode the MSI for each of the one or more PMCHs to determine MBSFN subframes of carrying MBMS services of interest. At 912, an L1 layer at the UE may be configured based at least on the MCCH and the MSI (e.g., by the RRC layer and/or MAC layer) to monitor the determined subframes of each PMCH for desired MBMS services. In aspects, operations 900 illustrated in FIG. 9 may be performed by one or more components 800A of a UE 650 in FIG. 8A.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As used herein, a phrase referring to “at least one of” a list of items refers to any combination of those items, including single members. As an example, “at least one of: a, b, or c” is intended to cover: a, b, c, a-b, a-c, b-c, and a-b-c.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication by a user equipment (UE), comprising:
receiving a Multicast Control Channel (MCCH) and Multicast Channel Scheduling Information (MSI) in a same subframe of a scheduling period, the MCCH and the MSI relating to one or more Multimedia Broadcast and Multicast Service (MBMS) services provided in a Multimedia Broadcast Single Frequency Network (MBSFN) area;
configuring at least a first control layer for the one or more MBMS services based on the MCCH;
retaining the MSI at least until the configuring is complete; and
configuring at least a second control layer for the one or more MBMS services based on the MSI.

2. The method of claim 1, further comprising:
decoding data for at least a portion of the scheduling period or not decoding data based on the MCCH and the decoded MSI.

3. The method of claim 2, further comprising executing a sleep procedure by the UE for one or more portions of the scheduling period during which data is not scheduled for the UE.

4. The method of claim 2, wherein the decoded data relates to at least one Evolved Multimedia Broadcast Multicast Service (eMBMS) service carried by a Physical Multicast Channel (PMCH).

5. The method of claim 1, wherein the scheduling period comprises a Multicast Channel Scheduling Period (MSP).

6. The method of claim 1, wherein:
the at least a first control layer comprises a Radio Resource Control (RRC) layer; and
the at least a second control layer comprises a Medium Access Control (MAC) layer.

7. The method of claim 6, wherein the MAC layer is configured by a Radio Resource Control (RRC) layer based on the MCCH.

8. The method of claim 6, wherein configuring the RRC layer based on the MCCH comprises:
providing information to the RRC layer regarding mapping of each Physical Multicast Control channel (PMCH) to logical channel identifiers of MBMS services carried by the PMCH.

9. The method of claim 8, wherein configuring the MAC layer based on the MSI comprises:
providing information to the MAC layer regarding position of all Multicast Traffic Channels (MTCH) used for Evolved Multimedia Broadcast Multicast Service (eMBMS) services and unused allocated MBSFN subframes on a Multicast Channel (MCH) for this particular PMCH.

10. The method of claim 8, wherein each logical channel identifier corresponds to a Evolved Multimedia Broadcast Multicast Service (eMBMS) service.

11. The method of claim 1, wherein retaining the MSI comprises storing the MSI.

12. The method of claim 1, wherein the one or more MBMS services comprise one or more Evolved Multimedia Broadcast Multicast Service (eMBMS) services.

13. An apparatus for wireless communication by a user equipment (UE), comprising:
means for receiving a Multicast Control Channel (MCCH) and Multicast Channel Scheduling Information (MSI) in a same subframe of a scheduling period, the MCCH and the MSI relating to one or more Multimedia Broadcast and Multicast Service (MBMS) services provided in a Multimedia Broadcast Single Frequency Network (MBSFN) area;
means for configuring at least a first control layer for the one or more MBMS services based on the MCCH;
means for retaining the MSI at least until the configuring is complete; and
means for configuring at least a second control layer for the one or more MBMS services based on the MSI.

14. The apparatus of claim 13, further comprising:
means for decoding data for at least a portion of the scheduling period or not decoding data based on the MCCH and the decoded MSI.

15. The apparatus of claim 14, further comprising:
means for executing a sleep procedure by the UE for one or more portions of the scheduling period during which data is not scheduled for the UE.

16. The apparatus of claim 14, wherein the decoded data relates to at least one Evolved Multimedia Broadcast Multicast Service (eMBMS) service carried by a Physical Multicast Channel (PMCH).

17. The apparatus of claim 13, wherein the scheduling period comprises a Multicast Channel Scheduling Period (MSP).

18. The apparatus of claim 13, wherein:
the at least a first control layer comprises a Radio Resource Control (RRC) layer; and
the at least a second control layer comprises a Medium Access Control (MAC) layer.

19. The apparatus of claim 18, wherein the MAC layer is configured by a Radio Resource Control (RRC) layer based on the MCCH.

20. The apparatus of claim 18, wherein the means for configuring the RRC layer based on the MCCH is configured to:
provide information to the RRC layer regarding mapping of each Physical Multicast Control channel (PMCH) to logical channel identifiers of MBMS services carried by the PMCH.

21. The apparatus of claim 20, wherein the means for configuring the MAC layer based on the MSI is configured to:
provide information to the MAC layer regarding position of all Multicast Traffic Channels (MTCH) used for Evolved Multimedia Broadcast Multicast Service (eMBMS) services and unused allocated MBSFN subframes on a Multicast Channel (MCH) for this particular PMCH.

22. The apparatus of claim 20, wherein each logical channel identifier corresponds to a Evolved Multimedia Broadcast Multicast Service (eMBMS) service.

23. The apparatus of claim 13, wherein the means for retaining the MSI is configured to storing the MSI.

24. The apparatus of claim 13, wherein the one or more MBMS services comprise one or more Evolved Multimedia Broadcast Multicast Service (eMBMS) services.

25. An apparatus for wireless communication by a user equipment (UE), comprising:
at least one processor configured to:
receive a Multicast Control Channel (MCCH) and Multicast Channel Scheduling Information (MSI) in a same subframe of a scheduling period, the MCCH and the MSI relating to one or more Multimedia Broadcast and Multicast Service (MBMS) services provided in a Multimedia Broadcast Single Frequency Network (MBSFN) area;
configure at least a first control layer for the one or more MBMS services based on the MCCH;
retain the MSI at least until the configuring is complete; and
configure at least a second control layer for the one or more MBMS services based on the MSI; and
a memory coupled to the at least one processor.

26. The apparatus of claim 25 wherein the at least one processor is further configured to decode data for at least a portion of the scheduling period or not decode data based on the MCCH and the decoded MSI.

27. A computer program product for wireless communication by a user equipment (UE), comprising:
a computer-readable medium comprising code for:
receiving a Multicast Control Channel (MCCH) and Multicast Channel Scheduling Information (MSI) in a same subframe of a scheduling period, the MCCH and the MSI relating to one or more Multimedia Broadcast and Multicast Service (MBMS) services provided in a Multimedia Broadcast Single Frequency Network (MBSFN) area;
configuring at least a first control layer for the one or more MBMS services based on the MCCH;
retaining the MSI at least until the configuring is complete; and
configuring at least a second control layer for the one or more MBMS services based on the MSI.

28. The computer program product of claim 27 further comprising code for decoding data for at least a portion of the scheduling period or not decoding data based on the MCCH and the decoded MSI.
